(19) United States
(12) Patent Application Publication
(10) Pub. No.: US 2025/0313736 A1
(43) Pub. Date: Oct. 9, 2025

(54) RESIN COMPOSITIONS FOR OPTICALLY CLEAR ADHESIVES AND METHODS OF ENHANCING ADHESION FORCES THEREOF

(71) Applicant: Ares Materials Inc., Dallas, TX (US)

(72) Inventors: Sudheendran Mavila, Sachse, TX (US); David Arreaga, Garland, TX (US); Adrian Avendano-Bolivar, Prosper, TX (US)

(21) Appl. No.: 19/173,638

(22) Filed: Apr. 8, 2025

Related U.S. Application Data
(60) Provisional application No. 63/631,723, filed on Apr. 9, 2024.

(51) Int. Cl. C09J 175/16; C08K 5/5445; C09J 5/00; C09J 7/30; C09J 9/00

(52) U.S. Cl. CPC C09J 175/16; C08K 5/5445; C09J 5/00; C09J 7/30; C09J 9/00; C09J 2301/208; C09J 2301/408; C09J 2301/416; C09J 2400/00; C09J 2475/00

(57) ABSTRACT

An optically clear adhesive (OCA) includes a polymeric resin composition. The polymeric resin composition includes 30 to 60 wt % of a thiol monomer, 20 to 60 wt % of at least one of a vinyl monomer or an allyl monomer, and 10 to 30 wt % of a difunctional aliphatic urethane oligomer. The polymeric resin composition further includes 1 to 3 wt % of a hydrolytic stabilizer additive, 1 to 5 wt % of a glycidyl monomer having at least one of an allyl functional group or an acrylate functional group, 0.1 to 1 wt % of a cyclic azasilane monomer, 0.5 to 2 wt % of a photoinitiator, and 0.01 to 0.03 wt % of a wetting additive. A method for enhancing adhesion forces of optically clear adhesives is also disclosed.

### CROSS-REFERENCE TO RELATED APPLICATIONS

This application claims priority to U.S. Provisional Patent Application No. 63/631,723, filed Apr. 9, 2024, and entitled “RESIN COMPOSITIONS FOR OPTICALLY CLEAR ADHESIVES AND METHODS OF PREPARING THE SAME,” the entire disclosure of which is incorporated herein by reference for all purposes.

### BACKGROUND

The use of foldable plastic-based electronic devices is becoming increasingly popular. Optically clear adhesives (OCA) play a vital role in maintaining flexibility and reducing stress on display components while folding the devices at different temperatures. These adhesives must have high optical transparency of over 90% and long-term reliability with minimal yellowing when exposed to heat, humidity, and UV rays. Current polyacrylate-based OCAs face challenges in achieving the desired low storage modulus at temperatures between −20° C. to 60° C. Moreover, when exposed to extreme weathering conditions, acrylate-based OCAs are prone to network stability issues, thus making it challenging to maintain the desired optical and thermomechanical properties under high humidity and temperature conditions for extended periods. Using thiol-click-based OCAs significantly improves the storage modulus as low as 0.2 or less within the temperature range of −20° C. to 60° C. and are able to maintain the mechanical performance even under 65° C. and 90% humidity weathering. However, the challenge remains in achieving high adhesion levels >1000 gf/in without substrate pretreatment.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a cross-sectional view of an optical laminate in accordance with certain embodiments of the present disclosure; and

FIG. 2, which is an illustration of a cross-sectional view of a flexible display in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present disclosure relates generally to materials relative to the field of resin compositions for flexible display technologies, and more particularly to methods for enhancing adhesion forces of optically clear adhesives (OCAs). In regard to the present disclosure, the term “adhesive” can include both permanent adhesives and pressure-sensitive adhesives (tacky adhesives). A pressure-sensitive adhesive may be repositionable and may function as a permanent adhesive by being subjected to a post-application treatment such as irradiation or heating with ultraviolet radiation.

Further in regard to the present disclosure, the term “optically clear” refers to a material having a haze value of approximately 2% or lower across the wavelength range 400 to 700 nm and a luminous transmittance of approximately 90% or higher. It is noted that haze can be determined in accordance with JIS K 7136 (2000) and luminous transmittance can be determined in accordance with JIS K 7361 (1997). Additionally, the term “optically clear” generally refers to a state in which air bubbles cannot be visually observed. Further in regard to the present disclosure, the term “storage modulus (G′)” refers to the storage modulus of a material at a specific temperature when a rate of temperature increase is measured at 5° C./min. and viscoelasticity is measured in a 1.0 Hz shear mode within a temperature range of −20° C. to 60° C. As a result of the methods disclosed herein, stable, low-modulus, and optically clear adhesives with salient optical, mechanical, and hydrolytic stability may be formed.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is an optically clear adhesive (OCA) having a polymeric resin composition configured for inclusion in flexible display technologies. The polymeric resin composition comprises 30 to 60 wt % of a thiol monomer, 20 to 60 wt % of at least one of a vinyl monomer or an allyl monomer, and 10 to 30 wt % of a difunctional aliphatic urethane oligomer. The polymeric resin composition further comprises 1 to 3 wt % of a hydrolytic stabilizer additive, 1 to 5 wt % of a glycidyl monomer having at least one of an allyl functional group or an acrylate functional group, 0.1 to 1 wt % of a cyclic azasilane monomer, 0.5 to 2 wt % of a photoinitiator, and 0.01 to 0.03 wt % of a wetting additive. For flexible display technology applications, the polymeric resin composition is cured into a film.

Additionally presented herein is an optical laminate comprising a first base layer having a first surface, a second base layer having a second surface, and an adhesive layer, where the adhesive layer includes the optically clear adhesive as described in the previous paragraph positioned between the first surface of the first base layer and the second surface of the second base layer so as to adhere the first surface of the first base layer to the second surface of the second base layer.

Additionally presented herein is a flexible display comprising a window layer, a polarizer layer, a display layer, a support film layer and a plurality of adhesive layers, where each of the plurality of adhesive layers include the optically clear adhesive as described in a previous paragraph, further where a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

According to one or more embodiments of the present disclosure, an amine-epoxide-based chemistry process is provided that exudes advancements that are not replicable using silane chemistry processes. For example, the amine-epoxide-based chemistry process/adhesion mechanism can successfully achieve an adhesion level of >1100 gf/in between adhesives and substrates under ambient conditions. This amine-epoxide-based approach additionally addresses critical issues associated with silane adhesion chemistry, such as the undergoing of self-coupling reactions that impact the mechanical performance of OCAs over time. In additional embodiments of the present disclosure, the development of a polymeric resin composition/blend is disclosed that is configured to create low-modulus, polysulfide-based OCAs that embody salient adhesion forces with various substrates that include, but are not limited to: glass, DOP, or PET.

According to an embodiment of the present disclosure, an optically clear adhesive (OCA) includes a polymeric resin composition configured for inclusion in flexible display technologies/materials. The composition of the adhesive utilizes certain multifunctional monomers and additives that are configured to improve the stability and performance of a typical OCA. The polymeric resin composition comprises 30 to 60 wt % of a thiol monomer, 20 to 60 wt % of at least one of a vinyl monomer or an allyl monomer, and 10 to 30 wt % of a difunctional aliphatic urethane oligomer. The polymeric resin composition further comprises 1 to 3 wt % of a hydrolytic stabilizer additive, 1 to 5 wt % of a glycidyl monomer having at least one of an allyl functional group or an acrylate functional group, 0.1 to 1 wt % of a cyclic azasilane monomer, 0.5 to 2 wt % of a photoinitiator, and 0.01 to 0.03 wt % of a wetting additive.

For flexible display technology applications, the polymeric resin composition is cured into an adhesive film having salient mechanical performance, where the polymeric resin composition is cured into the film using UVA light having an intensity of substantially 4 J/cm² at a temperature between room temperature and 80° C. The fully cured film produced embodies a low modulus and further embodies a first storage modulus between 0.05 and 0.2 MPa at −20° C. and a second storage modulus between 0.015 and 0.15 MPa at 60° C. when a rate of temperature increase is measured at 5° C./min and viscoelasticity is measured at a 1.0 Hz shear mode within a temperature range of −20° C. to 60° C. Additionally, the film exhibits excellent optical properties that include a haze of less than 1%, a yellowing index of less than 1, and an optical transmission rate of up to 94% in the 400 nm-700 nm wavelength range. The film further maintains its optical and thermomechanical properties even under high humidity (90%) and temperature (65° C.) for up to 240 hours.

A thiol monomer is a main component of the polymeric resin composition of the OCA. In certain embodiments, the thiol monomer comprises a functionality of 2 (difunctional) or 3 (trifunctional). A “difunctional” monomer, for reference purposes herein, comprises a chemical species that includes two thiolically unsaturated moieties. Similarly, a “trifunctional” monomer comprises a chemical species that includes three thiolically unsaturated moieties. Exemplary difunctional thiols that can be utilized include, but are not limited to: 1,4-bis(3-mercaptobutyroyloxy) butane, ethylene glycol bis-mercaptoacetate, ethylene bis(3-mercaptopropionate), 2,2′-(ethylenedioxy) diethanethiol, or 1,10-decanedithiol. In one embodiment, a species include: 1,4-bis(3-mercaptobutyroyloxy) butane or ethylene bis(3-mercaptopropionate). Exemplary trifunctional thiols that can be utilized include, but are not limited to: trimethylolpropane tris(3-mercaptopropionate) or tris [2-(3-mercaptopropionyloxy)ethyl] isocyanurate. In an embodiment, a species includes: tris [2-(3-mercaptopropionyloxy)ethyl] isocyanurate.

A vinyl monomer and/or an allyl monomer is another main component of the polymeric resin composition of the OCA. In certain embodiments, either of the vinyl monomer or allyl monomer comprises a functionality of 2 (difunctional) or 3 (trifunctional), the concept of which is understood in reference to the previous paragraph. Exemplary difunctional allyl monomers that can be utilized include, but are not limited to: diallyl isophthalate, trimethylolpropane diallyl ether, or triethyleneglycol divinyl ether. In an embodiment, a species includes: triethyleneglycol divinyl ether. Exemplary trifunctional allyl monomers that can be utilized include, but are not limited to: 1,3,5-triallyl-1,3,5-triazine-2,4,6 (1H,3H,5H)-trione or pentaerythritol triallyl ether. In an embodiment, a species includes: 1,3,5-triallyl-1,3,5-triazine-2,4,6 (1H,3H,5H)-trione.

A difunctional aliphatic urethane oligomer is another main component of the polymeric resin composition of the OCA. Exemplary difunctional aliphatic urethane oligomers that can be utilized include, but are not limited to: diallyl-trimethylhexamethylene diurethane.

It is noted that, in embodiments, disclosed methods may enhance an OCA to achieve an adhesion force with a glass substrate of greater than 1100 gf/in without requiring pretreatment on the substrate surface. To achieve this level of adhesion, the OCA is laminated to the substrate surface within 12 hours of aging.

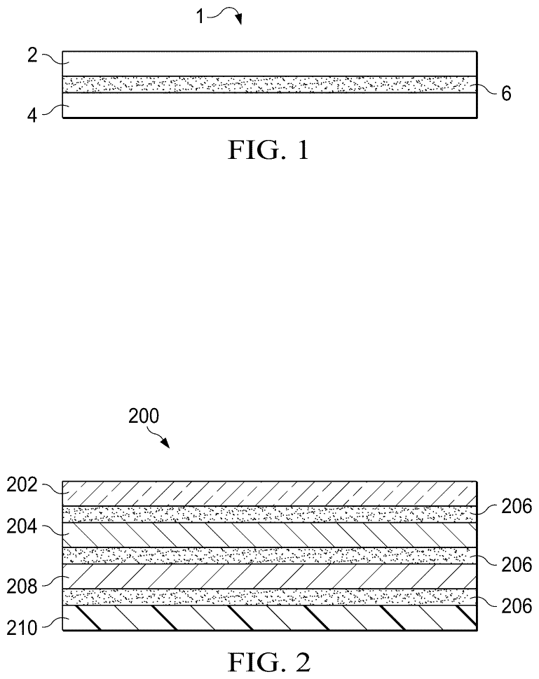

FIG. 1 is an illustration of a cross-sectional view of an optical laminate 1 in accordance with certain embodiments of the present disclosure. As shown, optical laminate 1 includes an adhesive layer 6 including an OCA positioned between and in contact with a first surface of a first base layer 2 and a second surface of a second base layer 4. Adhesive layer 6 may be in direct contact with the first surface of the first base layer 2 and the second surface of the second base layer 4. In other embodiments, adhesive layer 6 may be in indirect contact with the first surface of the first base layer 2 and the second surface of the second base layer 4, where one or more additional layers (not depicted) are positioned between adhesive layer 6 and the first surface of the first base layer 2 and between adhesive layer 6 and the second surface of the second base layer 4. The additional layers may include layers such as, but not limited to, hard coat layers, primer layers, polarizing layers, light emitting layers, or color filter layers. It is further noted that adhesive layer 6 may comprise any embodiment of an OCA disclosed.

FIG. 2 is an illustration of a cross-sectional view of a flexible display 200 in accordance with certain embodiments of the present disclosure. As shown, flexible display 200 includes a plurality of layers generally associated with a flexible display and includes a window layer 202, a polarizer layer 204, a display layer 208, and a support film layer 210. An adhesive layer 206 including an OCA is positioned between each pair of layers (202/204, 204/208, and 208/210). More specifically, one adhesive layer 206 of a plurality of adhesive layers 206 is positioned between and in contact with a first surface of window layer 202 and a first surface of polarizer layer 204, another adhesive layer 206 is positioned between and in contact with a second surface of polarizer layer 204 and a first surface of display layer 208, and another adhesive layer 206 is positioned between and in contact with a second surface of display layer 208 and a first surface of support film layer 210.

In other embodiments, adhesive layers 206 may be in indirect contact with the first surface of window layer 202, the first surface of polarizer layer 204, the second surface of polarizer layer 204, the first surface of display layer 208, the second surface of display layer, and the first surface of support film layer 210, where one or more additional layers (not depicted) are positioned between adhesive layers 206 and the first surface of window layer 202, the first surface of polarizer layer 204, the second surface of polarizer layer 204, the first surface of display layer 208, the second surface of display layer, and the first surface of support film layer 210. The additional layers may include layers such as, but not limited to, hard coat layers, primer layers, polarizing layers, light emitting layers, or color filter layers. It is noted that adhesive layers 206 may comprise any embodiment of an OCA disclosed. It is additionally noted that additional layers that are utilized in a flexible display and are separated by additional adhesive layers 206 can be included in the embodiment of flexible display 200, which can be recognized and understood by one skilled in the art.

According to an embodiment of the present disclosure, a method for enhancing an adhesion force of an OCA to a substrate utilizes a process illustrated by following Reaction Formula 1 that is carried out.

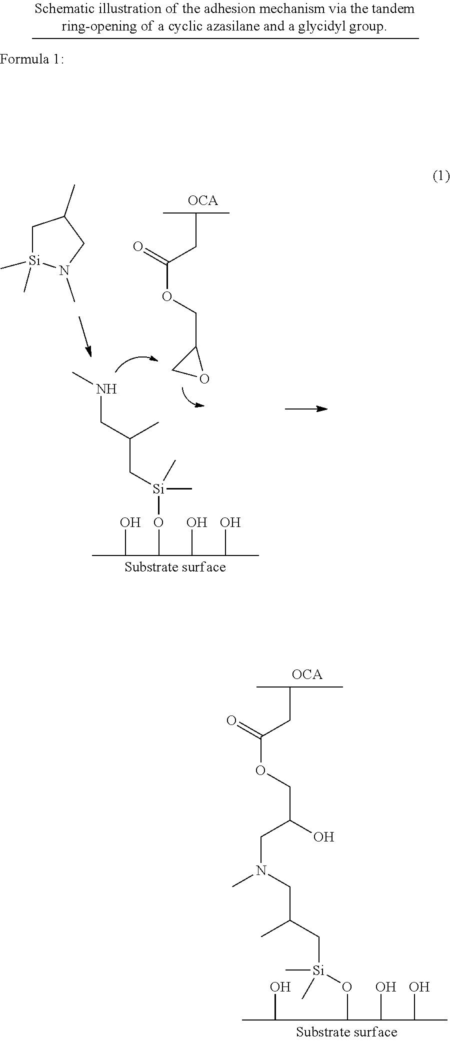

In embodiments, a method is disclosed that uses photopolymerizable glycidyl monomers and cyclic azasilane monomers to enhance the adhesion properties of OCAs to substrates using a tandem ring-opening mechanism. The adhesion process shown in Reaction Formula 1 above includes positioning cyclic azasilane monomers in the vicinity of a substrate surface, where the cyclic azasilane monomers are triggered into a ring-opening reaction by the substrate surface and the cyclic azasilane monomers attach to the hydroxyl groups located on the substrate surface. Once the first ring-opening reaction is carried out, a second ring-opening reaction is carried out, where epoxy functional groups of photopolymerizable glycidyl monomers located on the surface of the OCA are opened (ring-opening mechanism is carried out on the photopolymerizable glycidyl monomers) as a result of interactions with the reacted (ring-opened) cyclic azasilane monomers. As a result of the two ring-opening reactions, a covalent bond is formed between the OCA and the substrate at the interface of the OCA and the substrate. Additionally, the reacted OCA embodies excellent mechanical stability and optical properties, which makes the OCA beneficial for use in flexible display applications. In embodiments, the process comprises a glycidyl monomer having at least one of: one or more photopolymerizable allyl groups, one or more photopolymerizable acrylate groups, one or more photopolymerizable vinyl groups, or one or more photopolymerizable thiol groups.

In embodiments, the process comprises a first ratio of the glycidyl monomer to the cyclic azasilane monomer of 1 wt % to 0.5 wt %. This ratio may contribute to the improved adhesion of the OCA to substrates without pretreating the substrate. In addition, the ratio may promote an adhesion force of >1100 gf/in (without pretreatment). To achieve this amount of adhesion force, the OCA is laminated to the substrate surface within 12 hours of aging. If stored for an extended period of time (longer than 12 hours), the glycidyl monomers and the cyclic azasilane monomers are stored under an inert atmosphere, where guidelines for safe handling and storage procedures are provided to individuals handling the monomers. In an additional embodiment, the process comprises a second ratio of the glycidyl monomer to the cyclic azasilane monomer of 2 to 1.

One or more embodiments of this disclosure present materials for constructing higher quality and higher performing flexible display technologies in relation to other flexible display technologies.

It is noted that the optically clear adhesives (OCAs)/polymeric resins presented herein may be utilized in a display/display device/display panel that may be flexible or inflexible. The optically clear adhesives (OCAs)/polymeric resins may be incorporated into one or more layers of the display/display device/display panel that include, but are not limited to: a seal layer, a cathode layer, an emissive layer, an adhesive layer, a conductive layer, an anode layer, a substrate layer, and any layers mentioned in reference to FIG. 2. It is understood that the display/display device/display panel may include additional film layers that are not mentioned herein.

In an embodiment of the present disclosure, an electronic device may be provided that may utilize one or more optically clear adhesives (OCAs)/polymeric resins of the present disclosure in a display/display device/display panel associated with the electronic device. For exemplary purposes, the electronic device may be any of: a smart phone, a mobile phone, a video phone, a camera, a wearable device (such as electronic clothing, an electronic accessory, a smart watch, a head-mounted apparatus, an electronic bracelet, an electronic necklace, or an electronic tattoo), a personal digital assistant (PDA), a desktop computer (PC), a laptop PC, a netbook PC, a portable multimedia player (PMP), a digital audio player, a mobile medical apparatus, an e-book reader, etc. In additional embodiments, electronic device may be a smart home appliance including a display/display device/display panel. For exemplary purposes, the smart home appliance may be any of: an electronic key, a stereo, a TV, a set-top box, a television (TV) box, a video recorder, a game console, a vacuum cleaner, a digital video disk (DVD) player, a refrigerator, an air conditioner, an oven, a dryer, an air purifier, a microwave oven, a washing machine, an electronic dictionary, an electronic photo frame, etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, an optically clear adhesive (OCA) comprising: a polymeric resin composition comprising: 30 to 60 wt % of a thiol monomer; 20 to 60 wt % of at least one of a vinyl monomer or an allyl monomer; and 10 to 30 wt % of a difunctional aliphatic urethane oligomer.

Clause 2, the optically clear adhesive of Clause 1, wherein the polymeric resin composition further comprises: 1 to 3 wt % of a hydrolytic stabilizer additive; 1 to 5 wt % of a glycidyl monomer having at least one of an allyl functional group or an acrylate functional group; 0.1 to 1 wt % of a cyclic azasilane monomer; 0.5 to 2 wt % of a photoinitiator; and 0.01 to 0.03 wt % of a wetting additive.

Clause 3, the optically clear adhesive of Clause 1, wherein the polymeric resin composition is cured into a film.

Clause 4, the optically clear adhesive of Clause 3, wherein the polymeric resin composition is cured into the film using UVA light having an intensity of substantially 4 J/cm² at a temperature between room temperature and 80° C.

Clause 5, the optically clear adhesive of Clause 3, wherein, when the film is fully cured, the film comprises a first storage modulus between 0.05 and 0.2 MPa at −20° C. and a second storage modulus between 0.015 and 0.15 MPa at 60° C. when a rate of temperature increase is measured at 5° C./min.

Clause 6, the optically clear adhesive of Clause 1, wherein the thiol monomer comprises a functionality of 2 or 3.

Clause 7, the optically clear adhesive of Clause 1, wherein the at least one of a vinyl monomer or an allyl monomer comprises a functionality of 2 or 3.

Clause 8, the optically clear adhesive of Clause 3, wherein the film comprises a haze of less than 1%.

Clause 9, the optically clear adhesive of Clause 3, wherein the film comprises a yellowing index of less than 1.

Clause 10, the optically clear adhesive of Clause 3, wherein the film comprises an optical transmission rate of up to 94% in the 400 nm-700 nm wavelength range.

Clause 11, the optically clear adhesive of Clause 3, wherein the film comprises an adhesion force with glass substrates of greater than 1100 gf/in, further wherein the glass substrate is absent a pretreatment.

Clause 12, an optical laminate comprising: a first base layer having a first surface; a second base layer having a second surface; and an adhesive layer, wherein the adhesive layer includes an optically clear adhesive (OCA) comprising: a polymeric resin composition comprising: 30 to 60 wt % of a thiol monomer; 20 to 60 wt % of at least one of a vinyl monomer or an allyl monomer; and 10 to 30 wt % of a difunctional aliphatic urethane oligomer; wherein the adhesive layer is positioned between the first surface of the first base layer and the second surface of the second base layer so as to adhere the first surface of the first base layer to the second surface of the second base layer.

Clause 13, the optical laminate of claim 12, wherein the polymeric resin composition further comprises: 1 to 3 wt % of a hydrolytic stabilizer additive; 1 to 5 wt % of a glycidyl monomer having at least one of an allyl functional group or an acrylate functional group; 0.1 to 1 wt % of a cyclic azasilane monomer; 0.5 to 2 wt % of a photoinitiator; and 0.01 to 0.03 wt % of a wetting additive.

Clause 14, a method for enhancing an adhesion force of an optically clear adhesive (OCA) to a substrate, wherein a process illustrated by following Reaction Formula 1 is carried out.

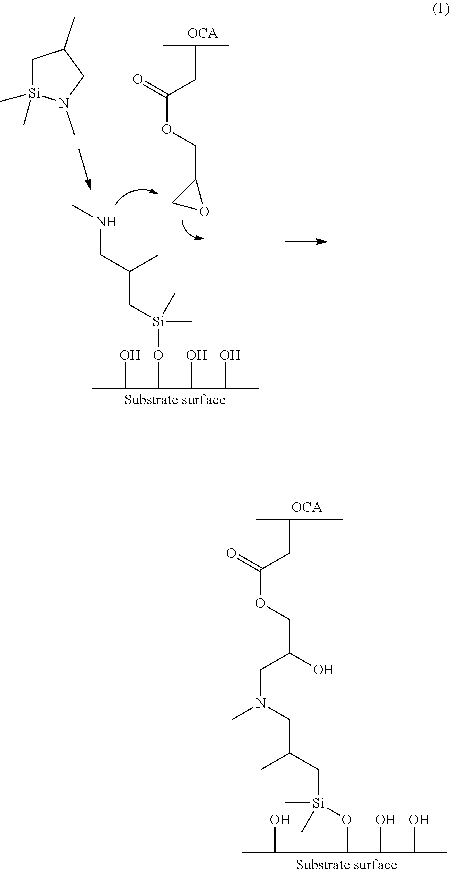

Clause 15, the method of Clause 14, wherein the process is carried out with a substrate that is absent a pretreatment.

Clause 16, the method of Clause 14, wherein the substrate comprises glass.

Clause 17, the method of Clause 14, wherein the process comprises a glycidyl monomer having at least one of: one or more photopolymerizable allyl groups, one or more photopolymerizable acrylate groups, one or more photopolymerizable vinyl groups, or one or more photopolymerizable thiol groups.

Clause 18, the method of Clause 14, wherein the process comprises a ratio of a glycidyl monomer to a cyclic azasilane monomer of 2 to 1.

Clause 19, the method of Clause 14, wherein the process comprises a ratio of a glycidyl monomer to a cyclic azasilane of 1 wt % to 0.5 wt %.

Clause 20, the method of Clause 19, wherein the ratio of the glycidyl monomer to the cyclic azasilane promotes an adhesion force of an optically clear adhesive (OCA) to a substrate of greater than 1100 gf/in.

Clause 21, the method of Clause 14, wherein the process comprises a tandem ring-opening mechanism.

Clause 22, a flexible display comprising: a window layer; a polarizer layer; a display layer; a support film layer; and a plurality of adhesive layers, wherein each of the plurality of adhesive layers includes an optically clear adhesive (OCA) comprising: a polymeric resin composition comprising: 30 to 60 wt % of a thiol monomer; 20 to 60 wt % of at least one of a vinyl monomer or an allyl monomer; and 10 to 30 wt % of a difunctional aliphatic urethane oligomer; wherein a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

Clause 23, the flexible display of Clause 22, wherein the polymeric resin composition further comprises: 1 to 3 wt % of a hydrolytic stabilizer additive; 1 to 5 wt % of a glycidyl monomer having at least one of an allyl functional group or an acrylate functional group; 0.1 to 1 wt % of a cyclic azasilane monomer; 0.5 to 2 wt % of a photoinitiator; and 0.01 to 0.03 wt % of a wetting additive.

What is claimed is:

1. An optically clear adhesive (OCA) comprising:
a polymeric resin composition comprising:
30 to 60 wt % of a thiol monomer;
20 to 60 wt % of at least one of a vinyl monomer or an allyl monomer; and
10 to 30 wt % of a difunctional aliphatic urethane oligomer.

2. The optically clear adhesive of claim 1, wherein the polymeric resin composition further comprises:
1 to 3 wt % of a hydrolytic stabilizer additive;
1 to 5 wt % of a glycidyl monomer having at least one of an allyl functional group or an acrylate functional group;
0.1 to 1 wt % of a cyclic azasilane monomer;
0.5 to 2 wt % of a photoinitiator; and
0.01 to 0.03 wt % of a wetting additive.

3. The optically clear adhesive of claim 1, wherein the polymeric resin composition is cured into a film.

4. The optically clear adhesive of claim 3, wherein the polymeric resin composition is cured into the film using UVA light having an intensity of substantially 4 J/cm² at a temperature between room temperature and 80° C.

5. The optically clear adhesive of claim 3, wherein, when the film is fully cured, the film comprises a first storage modulus between 0.05 and 0.2 MPa at −20° C. and a second storage modulus between 0.015 and 0.15 MPa at 60° C. when a rate of temperature increase is measured at 5° C./min.

6. The optically clear adhesive of claim 1, wherein the thiol monomer comprises a functionality of 2 or 3.

7. The optically clear adhesive of claim 1, wherein the at least one of a vinyl monomer or an allyl monomer comprises a functionality of 2 or 3.

8. The optically clear adhesive of claim 3, wherein the film comprises a haze of less than 1%.

9. The optically clear adhesive of claim 3, wherein the film comprises a yellowing index of less than 1.

10. The optically clear adhesive of claim 3, wherein the film comprises an optical transmission rate of up to 94% in the 400 nm-700 nm wavelength range.

11. The optically clear adhesive of claim 3, wherein the film comprises an adhesion force with glass substrates of greater than 1100 gf/in, further wherein the glass substrate is absent a pretreatment.

12. An optical laminate comprising:
a first base layer having a first surface;
a second base layer having a second surface; and
an adhesive layer, wherein the adhesive layer includes an optically clear adhesive (OCA) comprising:
a polymeric resin composition comprising:
30 to 60 wt % of a thiol monomer;
20 to 60 wt % of at least one of a vinyl monomer or an allyl monomer; and
10 to 30 wt % of a difunctional aliphatic urethane oligomer;
wherein the adhesive layer is positioned between the first surface of the first base layer and the second surface of the second base layer so as to adhere the first surface of the first base layer to the second surface of the second base layer.

13. The optical laminate of claim 12, wherein the polymeric resin composition further comprises:
1 to 3 wt % of a hydrolytic stabilizer additive;
1 to 5 wt % of a glycidyl monomer having at least one of an allyl functional group or an acrylate functional group;
0.1 to 1 wt % of a cyclic azasilane monomer;
0.5 to 2 wt % of a photoinitiator; and
0.01 to 0.03 wt % of a wetting additive.

14. A method for enhancing an adhesion force of an optically clear adhesive (OCA) to a substrate, wherein a process illustrated by following Reaction Formula 1 is carried out.

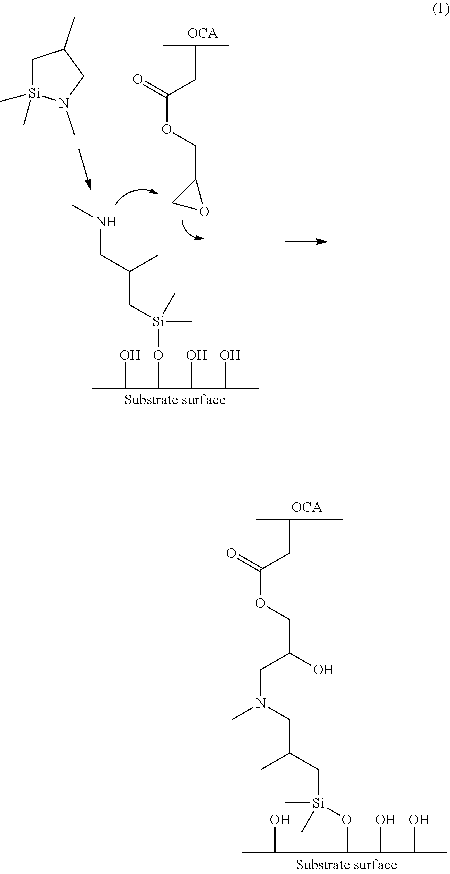

15. The method of claim 14, wherein the process is carried out with a substrate that is absent a pretreatment.

16. The method of claim 14, wherein the substrate comprises glass.

17. The method of claim 14, wherein the process comprises a glycidyl monomer having at least one of: one or more photopolymerizable allyl groups, one or more photopolymerizable acrylate groups, one or more photopolymerizable vinyl groups, or one or more photopolymerizable thiol groups.

18. The method of claim 14, wherein the process comprises a ratio of a glycidyl monomer to a cyclic azasilane monomer of 2 to 1.

19. The method of claim 14, wherein the process comprises a ratio of a glycidyl monomer to a cyclic azasilane of 1 wt % to 0.5 wt %.

20. The method of claim 19, wherein the ratio of the glycidyl monomer to the cyclic azasilane promotes an adhesion force of an optically clear adhesive (OCA) to a substrate of greater than 1100 gf/in.

21. The method of claim 14, wherein the process comprises a tandem ring-opening mechanism.

22. A flexible display comprising:
a window layer;
a polarizer layer;
a display layer;
a support film layer; and
a plurality of adhesive layers, wherein each of the plurality of adhesive layers includes an optically clear adhesive (OCA) comprising:
a polymeric resin composition comprising:
30 to 60 wt % of a thiol monomer;
20 to 60 wt % of at least one of a vinyl monomer or an allyl monomer; and
10 to 30 wt % of a difunctional aliphatic urethane oligomer;
wherein a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

23. The flexible display of claim 22, wherein the polymeric resin composition further comprises:
1 to 3 wt % of a hydrolytic stabilizer additive;
1 to 5 wt % of a glycidyl monomer having at least one of an allyl functional group or an acrylate functional group;
0.1 to 1 wt % of a cyclic azasilane monomer;
0.5 to 2 wt % of a photoinitiator; and
0.01 to 0.03 wt % of a wetting additive.
